(19) United States
(12) Patent Application Publication
(10) Pub. No.: US 2019/0359302 A1
(43) Pub. Date: Nov. 28, 2019

(54) FULL-FACE GOGGLE THAT A MICRO-CAMERA CAN BE ATTACHED TO

(71) Applicant: QBAS CO., LTD., Taipei (TW)

(72) Inventor: Chih-Cheng SHIUE, Taipei (TW)

(21) Appl. No.: 16/368,972

(22) Filed: Mar. 29, 2019

(30) Foreign Application Priority Data
May 24, 2018 (TW) 107206860

(51) Int. Cl. B63C 11/12; H04N 5/225

(52) U.S. Cl. CPC B63C 11/12; B63C 2011/126; H04N 5/2253

(57) ABSTRACT

A full-face goggle that a micro-camera can be attached to, including a frame portion and a detachable structure, is provided. The frame portion is assembled to a lens and a skirt portion so as to fit to a user's face. The micro-camera is pivotably and detachably attached to the bottom side of the frame portion via the detachable structure.

This application claims priority to Taiwan utility model Application No. 107206860 filed on May 24, 2018, the disclosure of which is hereby incorporated by reference in its entirety.

### CROSS-REFERENCES TO RELATED APPLICATIONS

Not applicable.

### BACKGROUND OF THE INVENTION

### Field of the Invention

The present invention relates to a full-face goggle, and more particularly, relates to a full-face goggle that a micro-camera can be attached to.

### Descriptions of the Related Art

With the innovation of mobile equipment and the increasing popularity of the internet, more and more users are used to keep a record of traveling activity and life in pieces and then sharing them with their family and friends by the mobile phone and digital camera.

However, the normal mobile phones or digital cameras are unable to be operated in the special environment (e.g., in the water, snow or desert) because they are not equipped with waterproof, cold resistant, heat resistant or dustproof and other special design. Therefore, some special micro-cameras (e.g., GoPro™) having the aforesaid resistant designs are popular with the users who like to do those activities in the special environments as mentioned above.

Actually, in use, such micro-cameras are mostly installed on the user's head for operation so as the image to be shot being the same as the angle of the user's sight. Once the aforesaid micro-camera is operated to record the underwater activity, it often has the problem that the aforesaid micro-camera is difficult to be installed on the goggles of performing the underwater activity and has trouble that is unable to adjust the shooting angle at any time.

Accordingly, there is an urgent need in the art to provide a full-face goggle which can easily connect with the aforesaid micro-camera and can allow the user to perform the adjustment of angle at the same time according to the different needs of the shooting.

### SUMMARY OF THE INVENTION

An objective of the present invention is to provide a full-face goggle that a micro-camera can be attached to. By the arrangement of a detachable structure, the user is allowed to easily install the micro-camera on the full-face goggle and can simply perform the adjustment of the angle at the same time according to the different needs of the shooting.

To achieve the aforesaid objective, a full-face goggle of the present invention that a micro-camera can be attached to, comprises a frame portion and a detachable structure. The frame portion is assembled to a lens and a skirt portion so as to fit to a user's face. The micro-camera can be pivotably and/or detachably attached to a bottom side of the frame portion via the detachable structure.

To achieve the aforesaid objective, the frame portion of the full-face goggle of the present invention further comprises a sliding groove that is disposed on the bottom side of the frame portion for inserting and attaching the detachable structure.

To achieve the aforesaid objective, the detachable structure of the full-face goggle of the present invention is a sliding block that is detachably attached to the sliding groove so that the micro-camera is pivotably and/or detachably attached on the sliding block.

To achieve the aforesaid objective, the detachable structure of the full-face goggle of the present invention comprises a sliding block and a curved shape rod. The sliding block is detachably attached to the sliding groove. One end of the curved shape rod is pivotably and/or detachably attached to the sliding block, and another end of the curved shape rod is used for installing the micro-camera so that the micro-camera can be moved to the front of the user by pivoting the curved shape rod.

To achieve the aforesaid objective, the bottom side of the frame portion of the full-face goggle of the present invention is relative to the chin side or cheek side of the user.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIGS. 1A to 1C are a perspective view and front views of the full-face goggle that a micro-camera can be attached to, according to the first embodiment of the present invention;

FIGS. 2A to 2B are the partial explosion views of the full-face goggle that a micro-camera can be attached to, according to the first embodiment of the present invention;

FIGS. 3A to 3B are the perspective views of the full-face goggle that a micro-camera can be attached to, according to the second embodiment of the present invention;

FIGS. 3C to 3D are the schematic views of performing the adjustment of the micro-camera according to the second embodiment of the present invention; and

FIGS. 4A to 4C are the perspective views and the usage schematic views of the full-face goggle that a micro-camera can be attached to, according to the third embodiment of the present invention.

### DESCRIPTION OF THE PREFERRED EMBODIMENT

The present invention is to provide a full-face goggle that a micro-camera can be attached to. The full-face goggle has a detachable structure which allows the user to easily install the micro-camera on the full-face goggle and can simply perform the adjustment of the angle at the same time according to the different needs of the shooting so that the excellent user experience is available.

The following describes the first embodiment of the present invention of the full-face goggle that the micro-camera can attached to.

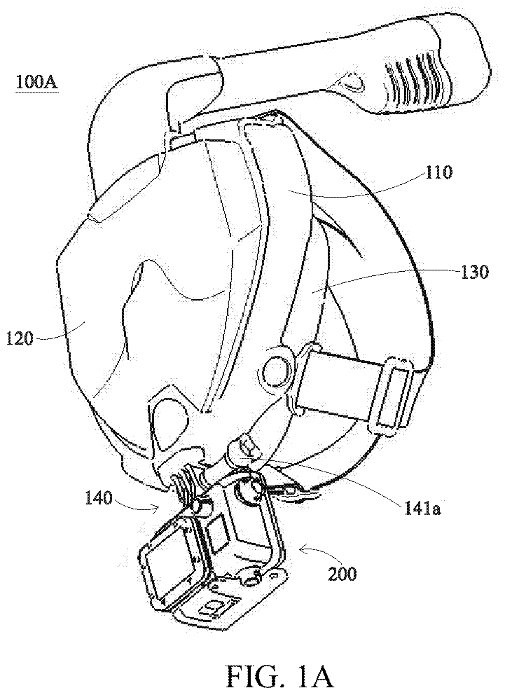

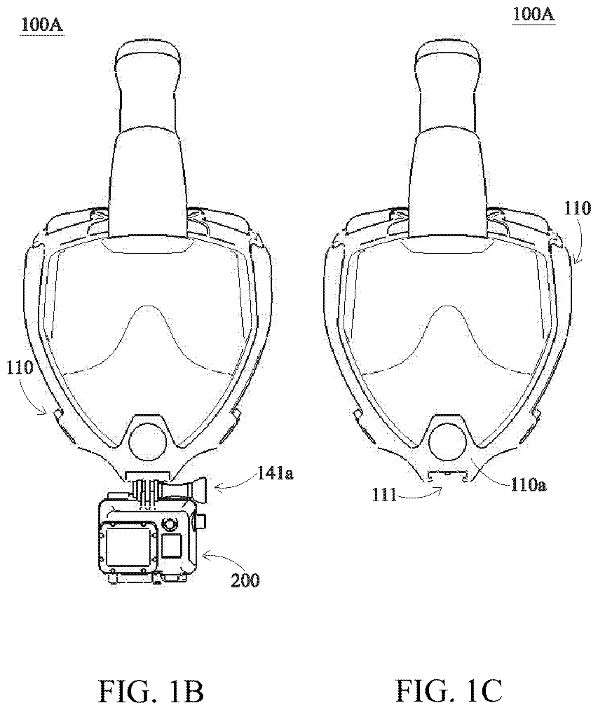

With respect to FIGS. 1A to 1C, in the first embodiment of the present invention, a full-face goggle that a micro-camera can be attached to, comprise: a frame portion 110, the lens 120, a skirt portion 130 and a detachable structure 140. The technical content of each of components will be described in sequence as below.

The main body of the full-face goggle 100A is assembled by the frame portion 110, the lens 120 and the skirt portion 130. Specifically, the lens 120 is made of a transparent hard material (e.g., thermoplastic plastic, glass or over-molding glass with thermoplastic plastic through injection molding). The lens 120 is surrounded by the frame portion 110 and thereby defining a field of vision. Moreover, in the particular embodiment, the top end of the lens 120 can further be disposed with a vent to connect with a ventilation pipe.

The skirt portion 130 is a soft material disposed around the periphery of the frame portion 110. When the user wears the full-face goggle 100A, an airtight fit is formed between the full-face goggle 100A and the user's face by the proper deformation of the skirt portion 130 caused by the face contour of the user.

As shown in FIGS. 1A to 1C, the frame portion 110 further includes a sliding groove 111 in order to connect the full-face goggle 100A with the micro-camera 200. Moreover, in this embodiment, the sliding groove 111 is preferably disposed on the bottom side 110a of the frame portion 110 (i.e. relative to the chin side of the user) for inserting and attaching the detachable structure 140 that connects the micro-camera 200.

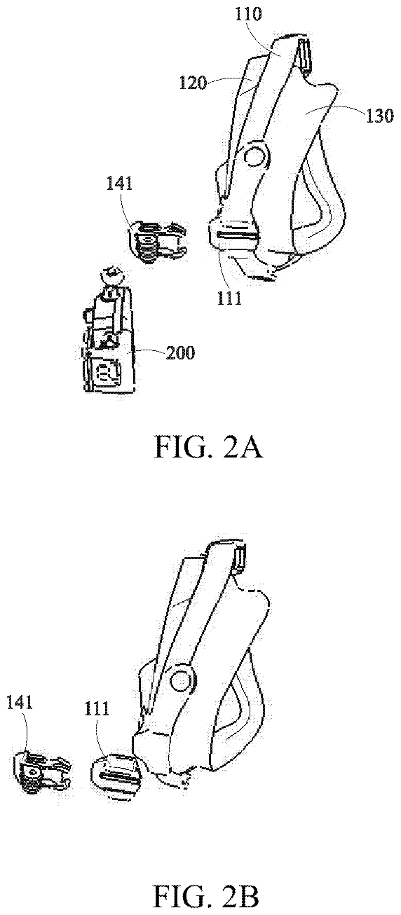

As shown in FIG. 2A, the sliding groove 111 can have a shape to be integrally formed with the frame portion 110. Alternatively, as shown in FIG. 2B, the sliding groove 111 is formed as an individual component and then being disposed and attached to the bottom side 110a of the frame portion 110 via the processing methods such as assembly, encapsulation, and adhesive.

The detachable structure 140 is used for connecting the micro-camera 200 with the full-face goggle 100A so that the micro-camera 200 can be pivotably and/or detachably attached to a bottom side 110a of the frame portion 110 by the arrangement of the detachable structure 140.

As shown in FIGS. 2A-2B, in this embodiment, the detachable structure 140 is a sliding block 141 corresponding to the sliding groove 111. The sliding block 141 slides into the sliding groove 111 in a sliding manner, thereby being detachably attached into the sliding groove 111. In addition, the sliding block 141 has a fastening member 141a that can be connected with the micro-camera 200; the fastening member 141a can use screws, tenons and other mechanisms so that the micro-camera 200 can be pivotably and/or detachably attached on the sliding block 141. Thereby, the user can appropriately adjust the shooting angle of the micro-camera 200 according to the object who want to record.

The above are the descriptions of the components of the full-face goggle 100A, and the following will further describe the processing method thereof.

It only needs to attach the micro-camera 200 with the detachable structure 140 (i.e. the sliding block 141) when the user wants to install the micro-camera 200 on the full-face goggle 100A, and then using the simple sliding manner to conform that the sliding block 141 is inserted into the sliding groove 111 located at the bottom side 110a of the frame portion 110 and positioned it therein. The user can also detach the micro-camera 200 from the full-face goggle 100A through the reversed operation relative to the aforementioned manner. In other words, the user is in a condition without taking off the full-face goggle 100A by the arrangement of the detachable structure 140 of the present invention so that the micro-camera 200 can be easily installed on or detached from the full-face goggle 100A.

In addition, as shown in FIG. 1C, if the full-face goggle 100A is in a condition without attaching the micro-camera 200, its frame portion 110 will not have the protruding component so as to avoid obstructing underwater activities of the user.

The followings will describe the full-face goggle of other embodiments in the present invention. The same technical portion will be omitted or simplified because the technical content of the full-face goggle in each of the embodiments can be referred to each other.

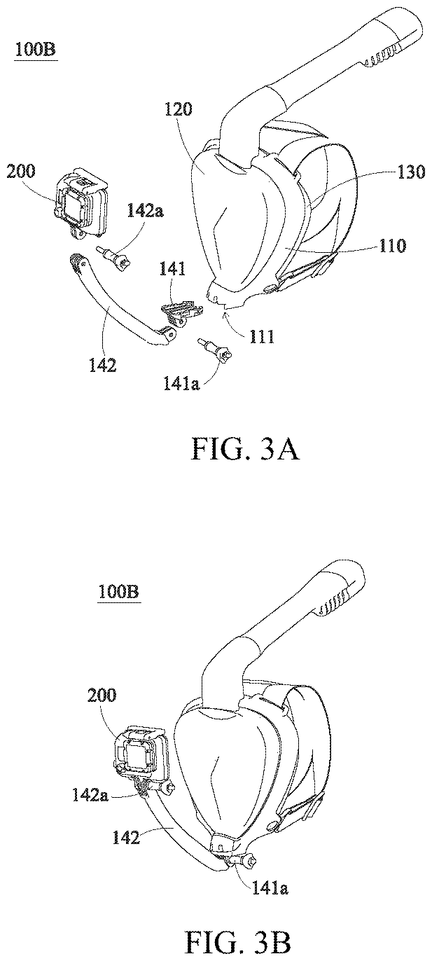

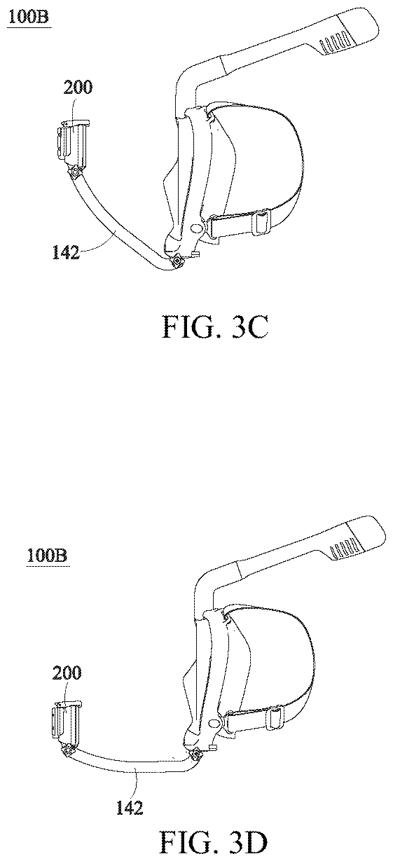

Please refer to FIGS. 3A to 3B, which are the second embodiment (i.e. the full-face goggle 100B) of the present invention of the full-face goggle that a micro-camera 200 can attach to. The difference between the full-face goggle 100B and the full-face goggle 100A is that: the detachable structure 140 of the full-face goggle 100B further comprises a curved shape rod 142. The more specific related descriptions are as follows:

In the second embodiment of the present invention, the full-face goggle 100B also comprises a frame portion 110, a lens 120 and a skirt portion 130, and the bottom of the frame portion 110 is also disposed with a sliding groove 111. However, the detachable structure 140 of the full-face goggle 100B further includes a curved shape rod 142 besides the sliding block 141.

Specifically, the sliding block 141 of the detachable structure 140 can detachably attached inside the sliding groove 111 by sliding. One end of the curved shape rod 142 can be povitably and/or detachably attached on the fastening member 141a of the sliding block 141, and another end of the curved shape rod 142 can connect with the micro-camera 200 via a secondary fastening member 142a. In other words, this embodiment can further adopt the curved shape rod 142 so as to provide a larger position of adjustment range for the micro-camera 200 that is disposed on the frame portion 110.

In use, as shown in FIGS. 3C-3D, the user can adjust the position of the micro-camera 200 via the pivot of the curved shape rod 142 (e.g., at the fastening member 141a and/or the secondary fastening member 142a) so that it is selectively moved to the front of the user (i.e. within the field of vision) for setting or recording. In addition, in particular embodiment, the curved shape rod 142 can be made by further selecting from the flexible material such that the rod itself can form the proper deformation to allow the user to adjust the position of the micro-camera 200 with more freedom, and thus easy to use or various shooting and other usages can be achieved.

It shall be further appreciated that, in the particular embodiment, the sliding block 141 and the curved shape rod 142 can also present an integrated form to simplify its process and the amount of the components to be assembled.

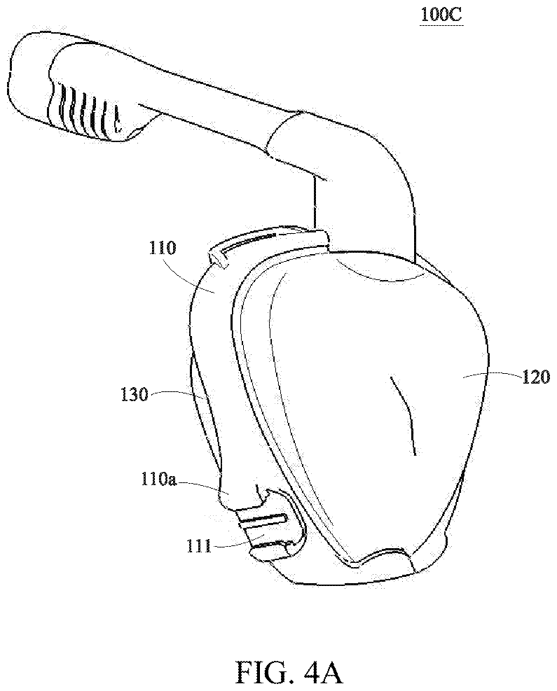

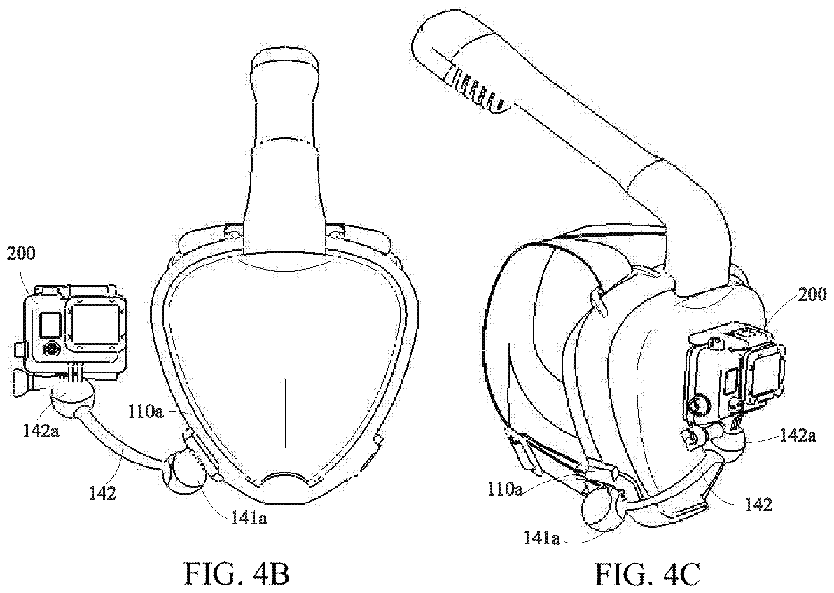

In the third embodiment of the full-face goggle 100C that a micro-camera 200 can be attach to as shown in FIGS. 4A to 4C, the difference between the full-face goggle 100C and the full-face goggle 100B is that: the sliding block 111 of the full-face goggle 100C is disposed on the bottom side 110a of the frame portion 110 and the bottom side 110a is relative to at least one cheek side of the user.

In detail, in the third embodiment of the present invention, the full-face goggle 100C also comprises a frame portion 110, a lens 120, a skirt portion 130 and a detachable structure 140, wherein the sliding groove 111, however, is disposed on the bottom side 110a of the frame portion 110, and the bottom side 110a is relative to at least one cheek side of the user. In addition, to adapt the usage habits of the different user, the two bottom sides of the frame portion 110 relative to the left and right cheeks can be separately provided with a sliding groove 111 so that the user can adjust the installing position of the micro-camera 200 accordingly.

In other words, in the third embodiment, the frame portion 110 has not only a type of a single sliding groove 111 to be disposed with respect to one of the cheek sides of the user but also a type of two sliding grooves 111 to be disposed with respect to both of the two cheek sides of the user.

When the micro-camera 200 is attached to the cheek sides of the frame portion 110 via the curved shape rod 142, it can ensure that the photographic range of the micro-camera 200 and the sight of the user are in horizontal so as to entirely record the underwater activities. In addition, the position of the micro-camera 200 can be easily adjusted to avoid it shielding the sight of the user (as shown in FIG. 4C) when the user wants to seek a larger field of vision.

In summary, the full-face goggle of the present invention can allow the user to easily attach the micro-camera on the full-face goggle or detach the micro-camera from the full-face goggle via the arrangement of the detachable structure, and thus it is effective to improve the user experience and enhance the effect of its shooting recording.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A full-face goggle that a micro-camera can be attached to, comprising:
a frame portion, being assembled to a lens and a skirt portion so as to fit to a user's face; and
a detachable structure, the micro-camera is pivotably and/or detachably attached to a bottom side of the frame portion via the detachable structure.

2. The full-face goggle as claimed in claim 1, wherein the frame portion further comprises a sliding groove that is disposed on the bottom side of the frame portion for inserting and attaching the detachable structure.

3. The full-face goggle as claimed in claim 2, wherein the detachable structure is a sliding block that is detachably attached to the sliding groove so that the micro-camera is pivotably and/or detachably attached on the sliding block.

4. The full-face goggle as claimed in claim 2, wherein the detachable structure comprises a sliding block and a curved shape rod, wherein the sliding block is detachably attached to the sliding groove, one end of the curved shape rod is pivotably and/or detachably attached to the sliding block, and another end of the curved shape rod is used for installing the micro-camera so that the micro-camera can be moved to the front of the user by pivoting the curved shape rod.

5. The full-face goggle as claimed in claim 1, wherein the bottom side of the frame portion is relative to the chin side or cheek side of the user.
